(19) United States
(12) Patent Application Publication
(10) Pub. No.: US 2008/0136658 A1
(43) Pub. Date: Jun. 12, 2008

(54) Tilting Display Assembly and Method

(76) Inventor: Kenneth Alan Brask, Lindenhurst, IL (US)

Correspondence Address: VEDDER PRICE KAUFMAN & KAMMHOLZ, 222 N. LASALLE STREET, CHICAGO, IL, 60601, US

(21) Appl. No.: 11/952,301

(22) Filed: Dec. 7, 2007

Related U.S. Application Data
(60) Provisional application No. 60/869,525, filed on Dec. 11, 2006.

(51) Int. Cl. G09F 19/00

(52) U.S. Cl. 340/815.4

(57) ABSTRACT

The present disclosure relates to an assembly and method for use of an electronic display, and more particularly, to an electronic display device including a proximity sensor and a switch for a handicap or a small person both connected to a tilting mechanism. The display in a first attract orientation shows an attract graphic to incite users toward the display. Once a user has been detected by the proximity sensor, the assembly tilts the display device toward the face of a user and the attract graphic is replaced by an access graphic operated via the touch screen. In the event a handicapped person or a short person wishes to access the display assembly, a switch is activated to rotate the display device downwards to a user sitting in a chair.

### RELATED APPLICATION

This application claims the benefit of and priority from U.S. Provisional Patent Application No. 60/869,525, filed on Dec. 11, 2006, entitled TILTING DISPLAY ASSEMBLY AND METHOD, which application is expressly incorporated herein by reference.

### FIELD OF THE DISCLOSURE

The present disclosure relates to an assembly and method for use of an electronic display, and more particularly, to an electronic display device including a proximity sensor and a switch connected to a tilting mechanism, where the display device is connected to a computing device to convey various visual messages and an interface with a representative.

### BACKGROUND

Sellers of goods have long sought improved means to advertise their goods and/or provide a value-added service in a manner that increases overall productivity or enhance sales. A key feature pertinent to the sale of goods or services is to attract and maintain the attention of buyers in an environment making them receptive to acquiring goods or services. The use of a multimedia presentation on a display at a point of sale is known to promote sales as marketing tools. Some retail and wholesale stores allow suppliers to place monitors driven by a source on an endless loop next to their products or services to enhance sales. Other stores display movies or any other multimedia support, such as a movie trailer, to promote the sale of said movie.

Improved multimedia displays help enhance or promote the sale of goods or services. Of course, the examples of such displays used in connection with the sale of goods should not be construed in a limiting sense and is only one example of the myriad applications for an improved multimedia display. The usefulness of multimedia joint audio and video displays in the marketplace, as well as any other possible uses, is well known to one of ordinary skill in this art.

The technical requirements of a multimedia display device depend on the intended use of the display. Generally, most message-conveying devices need to be durable, user friendly, robust, and affordable. The devices may also work without the help of a sales representative and attract the attention of a user without contributing excessively to ambient auditory pollution. Often, a display device is left unattended on a stand or in a store. For this reason, the device must not be portable and must offer some level of theft protection. These devices must also be attractive enough to enhance the purchase experience while allowing flexibility in the creation and use of visual and possibly audio messages. The devices must ultimately capture the attention of an end user long enough to cause him/her to see and hear the entire message and be accessible by nearly all segments of the population.

The needs of the purchasers/owners of multimedia display devices may differ in some aspects from the needs of the ultimate consumer of the goods. Owners need display devices that can be modified easily and that convey a wide range of audio and video messages in a plurality of formats, systems of exploitation, and transmission protocols. Owners also benefit from the acquisition of a display device that uses existing technology known to its employees and can be adapted to be displayed in different orientations. Some orientations, such as a lower position, is often associated with an individual sitting in a wheelchair, children, or other persons of limited height.

Several other devices already exist for conveying a message at a point of purchase of goods or services consisting of a video and possibly an audio display. The prior art discloses a device where six pictures are arranged on a flat, retro-lit panel shown over a tape-recorded narrative. Another describes a point-of-purchase advertising system that utilizes an ultrasonic transducer to sense the presence of a person in the vicinity of the display and uses an endless tape playback unit for playing prerecorded advertisements on a speaker. Yet another describes a display device equipped with an infrared sensor and an audio speaker that activates a retro-illuminated display made of two nonoverlapping transparencies.

More recently, devices have evolved to include digital displays such as flat screen monitors or plasma televisions. One describes a blind, fixed audio and visual, waist-high terminal display station able to connect to the Internet and display different types of presentations. Another describes an interactive advertising system where a user is able to retrieve information stored on a display device via a touch screen system. Neither is equipped with a proximity sensor to activate the device when the user is nearby or deactivate the device when the user is absent. Yet another describes a public restroom system where an audio speaker and a video display screen are activated by a proximity sensor connected to a single control apparatus with limited audiovisual data processing capacity.

Although many of these devices are able to perform their intended functions in a workmanlike manner, none of them solve all of the drawbacks described above. What is needed is a display assembly that allows a display owner to broadcast to a user a variety of visual data and complementary audio data from a computer to a user using a multiformat screen, benefiting from simple and standardized connectors and cables technology, functionally grouping a proximity sensor technology along with the audio and video technology, and providing a tilting mechanism for the screen that overcomes the limitations of the prior art to provide associated functionality that further enhances the use of the display.

### SUMMARY

The present disclosure relates to an assembly and method for use of an electronic display, and more particularly, to an electronic display device including a proximity sensor and a switch for a handicap or a small person both connected to a tilting mechanism. The display in a first attract orientation shows an attract graphic to incite users toward the display. Once a user has been detected by the proximity sensor, the assembly tilts the display device toward the face of a user and the attract graphic is replaced by an access graphic operated via the touch screen. In the event a handicapped person or a short person wishes to access the display assembly, a switch is activated to rotate the display device downwards to a user sitting in a chair.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1A is a perspective view of the front portion of the electronic display assembly in a attract orientation according to an embodiment of the present disclosure.

FIG. 1B is a perspective view of the front portion of the electronic display assembly of FIG. 1A in an access orientation according to an embodiment of the present disclosure.

FIG. 1C is a perspective view of the front portion of the electronic display assembly of FIG. 1A in a handicap orientation according to an embodiment of the present disclosure.

FIG. 2 is a front view of the electronic display assembly of FIG. 1A in the access orientation.

FIG. 3 is diagrammatic rear view of the electronic display assembly of FIG. 1A in the access orientation.

FIG. 4 is a close-up view of the tilting mechanism of the electronic display assembly as shown in FIG. 3 according to an embodiment of the present invention.

FIG. 5 is a block diagram of the method of tilting an electronic display assembly according to another embodiment of the present disclosure.

### DETAILED DESCRIPTION OF THE PREFERRED EMBODIMENTS

For the purposes of promoting and understanding the principles disclosed herein, reference is now made to the preferred embodiments illustrated in the drawings and specific language is used to describe the same. It is nevertheless be understood that no limitation of the scope is hereby intended. Such alterations and further modifications in the illustrated devices and such further applications of the principles disclosed and as illustrated herein are contemplated as would normally occur to one skilled in the art to which this disclosure relates.

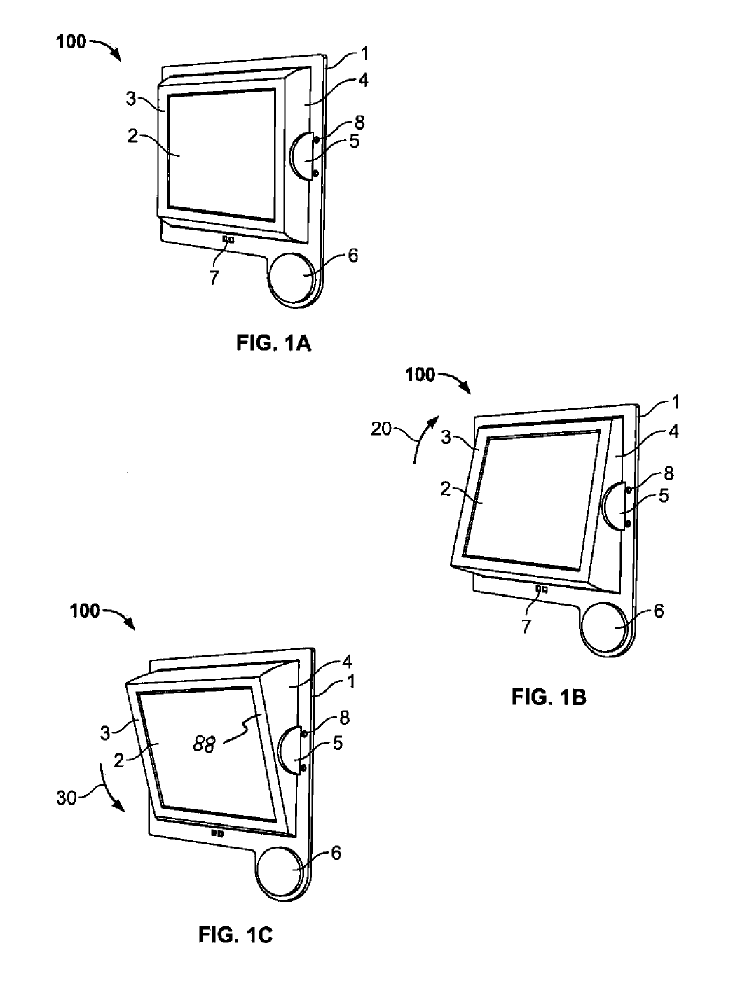

FIGS. 1A to 1C show perspective views of the front portion of an electronic display assembly 100 in an attract orientation (FIG. 1A), an access orientation (FIG. 1B), and a handicap or short user orientation (FIG. 1C). The display assembly 100 includes a frame 1 with an electronic display device 3 pivotally connected to the frame 1 with a tilting mechanism 5 shown by two large circular disks on the sides of the electronic display device 3. FIG. 1A shows a configuration where display surface 2 of the display device 3 is essentially vertical. FIG. 1B shows as 20 a situation where the display device 3 and the display surface 2 has been tilted up into an access orientation. In one preferred embodiment, the access orientation is tilted down approximately 10 degrees from the attract configuration. FIG. 1C shows as 30 a situation where the display device 3 and the display surface 2 has been tilted into a handicap orientation. In another preferred embodiment, the handicap orientation is tilted downward by approximately 10 degrees from the attract configuration.

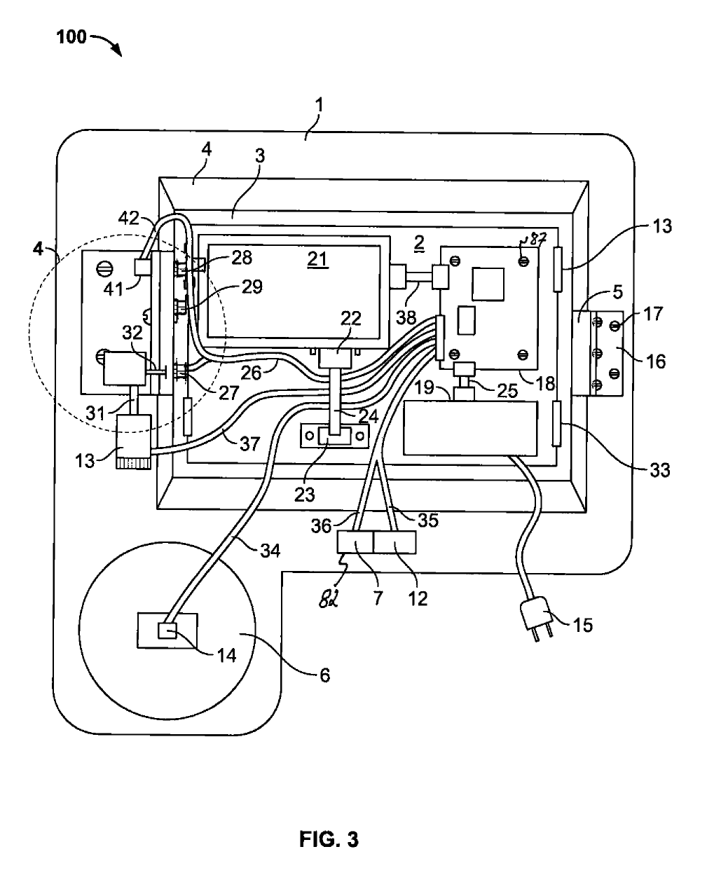

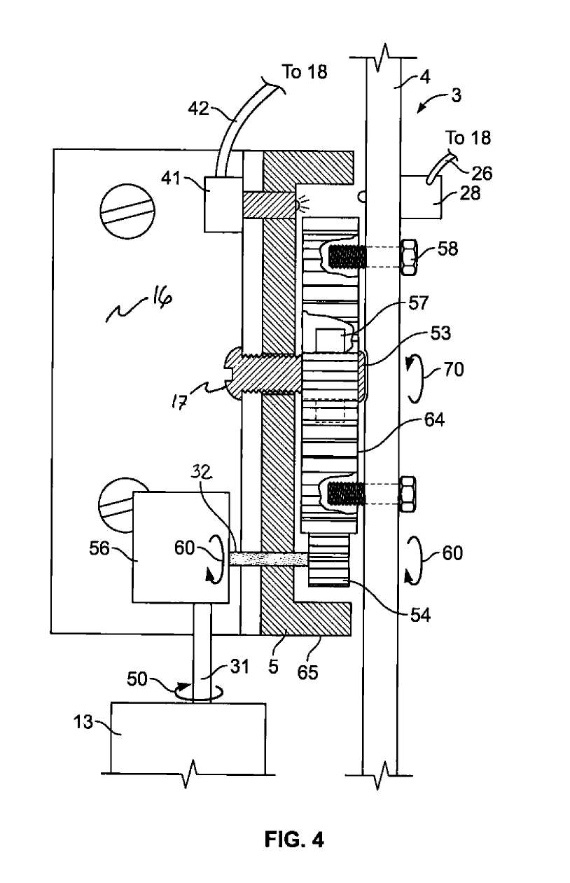

FIGS. 1A-1C show the frame 1, and an electronic display device 3 pivotally connected to the frame 1 with a display surface 2, a control board 18 as shown in FIG. 3, and a tilting mechanism 5 shown in greater detail in FIG. 4 at the pivotal connection between the frame 1 and the display device 3 for relative movement of the electronic display device 3 and the frame 1 between the above-described attract orientation, access orientation, and handicap orientation as shown in FIGS. 1A-1C.

It is contemplated that to pivot the display device 3 to an orientation where a user standing upright and within reach of the display surface 2 is able to touch the display surface 2 and view images displayed on the display surface 2. By way of example, if the display assembly 100 is placed lower than the shoulders of the user on a wall or other upright surface, the display surface 2 must in fact be tilted upwards at a certain angle for optimal viewing by the user; in contrast, if the display assembly 100 is placed higher than the shoulders of the user on the wall, then the display surface 2 must be tilted downward by a certain angle for optimal viewing. The handicap orientation shown in FIG. 1C corresponds generally to a situation where a person in a wheelchair, having a limited height, must operate the display assembly 100 to view the display surface 2. A display device 3 is also rotated around a horizontal axis and tilting upward and downward between the three different orientations. Further orientations of axis and tilting are contemplated based on any operating parameter. One of ordinary skill in the art will recognize that while the most obvious situation is described and shown, the gist of this disclosure is equally applicable to other situations.

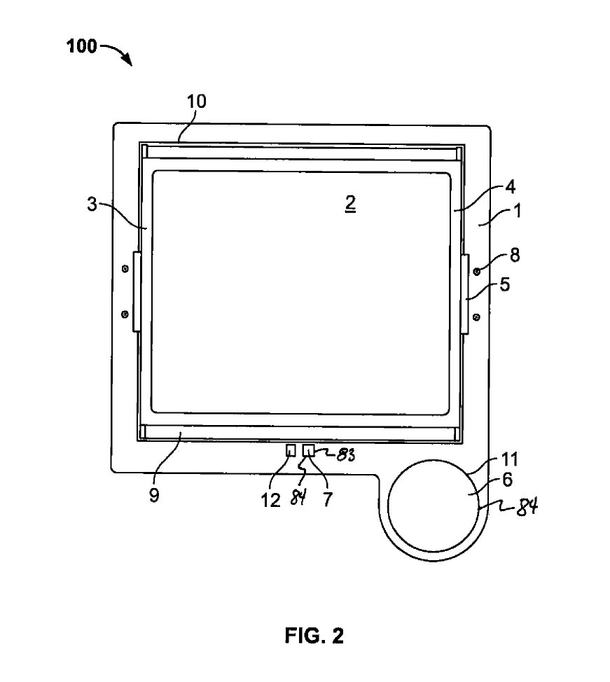

FIG. 3 is one proposed embodiment of the internal elements associated with the electronic display assembly 100. In one alternate embodiment, the electronic display device 3 further comprises a reinforced shell 4. FIGS. 1A-1C show how the reinforced shell 4 can be made of a rigid material such as aluminum or plastic. The reinforced shell 4 has curved top and bottom exterior surfaces at a constant radius from the tilting mechanism 5 to allow for the electronic display device 3 to slide and rotate within a third opening 9 forming a third edge 10 for housing the reinforced shell 4 as shown in FIG. 2. One other known advantage of having curved top and bottom exterior surfaces is to prevent any possible opening between the reinforced shell 4 and the third edge 10 that can be hazardous when the tilting mechanism 5 rotates the electronic display device 3 from one orientation to the next. The reinforced shell 4 as shown includes a front edge 88 and a securing means 13, 33 as shown in FIG. 3 to hold the display surface 2 in position. While tabs are shown as a securing means 13, 33, any type of device capable of securing the display surface 2 in place can be used.

Further, the electronic display assembly 100 includes a proximity sensor 7 with a detection level. In one embodiment, the sensor is a digital infrared emitter and receiver shown as 82, 12. Infrared is a light spectrum generally not perceived by humans. As the emitter 82 emits light, a portion is reflected back to the received 12 after hitting a proximate target in an area of use located next to the proximity sensor 7. The proximate sensor 7 is connected to the control board 18 where a detection level is fixed based on a plurality of parameters generally known in the art. As a potential user of the electronic display assembly 100 approaches the area of the display assembly 100, the amount of reflected infrared light increases until a preset detection level is reached. While an infrared sensor is shown and disclosed, other types of sensors can be used with equal efficiency capable of proximate detection of a user.

Next, the electronic display assembly 100 includes a switch 6 connected to the control board 18 as shown in FIG. 3. In one embodiment, the switch 6 is touch sensitive with or without thermal reading and has an embedded graphic such as a handicap sign. The use of any external control system to enable the handicap or a short person's orientation is also contemplated. For example, the display surface 2 with a touch screen portion can show a switch and the associated symbol, a special proximity detector can recognize the presence of a metallic wheelchair in proximity of the detector, or an impedance detector can be used where a user must simply touch a metallic part of the display assembly 100 and change the impedance of the system by adding the capacitance and impedance of the human body to a fixed value. One of ordinary skill will recognize that while one type of switch or control is shown, what is contemplated is the use of any useful enabling control that can be used to activate the handicap orientation shown in FIG. 1C.

FIG. 3 is diagrammatic rear view of the electronic display assembly 100 of FIG. 1A in the access orientation. A control board 18 is functionally linked with a computing device 21 with or without a display screen. The computing device 21 includes at least one data port 22 connected to a communication port 23 of the electronic display device 3. In one embodiment, the communication port 23, and the data port 22 are universal serial buses (USB ports). While one type of connection or port is shown, any type of port or means of digital or data communication, including but not limited to wireless communication, can be used. The computing device 21 is also connected to the control board 18 by a connection cable 38. As shown, the control board 18 is fixed by screws 87, one of any number of contemplated methods of fixing different elements on the back side of the electronic display device 3. A power supply 19 is also shown to be connected 25 to the control board 18 to energize the different elements of the electronic display assembly 100. In one embodiment, the power supply 19 is not a self-supporting power supply such as a battery or a solar panel but is connected as a transformer to a power outlet 15 to redirect either alternating or continuous current either directly to the different components of the electronic display assembly 100 (not shown) or through the control board 18 including a power distribution system.

In one preferred embodiment, the computing device 21 is implemented on a personal computer of IBM-type technology, or other operating systems such as Mac OS, Linux, or the like. In another embodiment, solid-state media players are used. In general, such computing devices 21 for interactive product display purposes comprise a bus for communicating information, a processor coupled with the bus for processing information, main memory coupled with the bus for storing the information and instructions for the processor, a display device (touch screen) coupled with the bus for displaying information for a computer user, an input device (touch screen) coupled with the bus for communicating information and command selections to the processor, and a mass storage device, such as a magnetic disk or flash memory and associated disk drive, coupled with the bus for storing information and instructions. A data storage medium containing digital information is configured to operate with the mass storage device to allow the processor access to the digital information on data storage medium via the bus.

In one embodiment, the control board 18 energizes the tilting mechanism 5 shown in detail in FIG. 4 to pivot the electronic display device 3 from the attract orientation of FIG. 1A to the access orientation of FIG. 1B when the detection level of the sensor 7 is reached. The electronic display device 3 also pivots from the access orientation of FIG. 1B to the handicap orientation of FIG. 1C when the switch 6 is enabled.

In one contemplated embodiment (not shown), an audio speaker is connected to the electronic display device 3 to provide audio signal along with any video signal displayed on the display surface 2. FIG. 2 is a front view of the electronic display assembly of FIG. 1A in the access orientation. In one embodiment, the frame 1 includes a first opening 81 forming a first edge 11 connected to the switch 6 and a second opening 84 forming a second edge 83 connected to the proximity sensor 7. What is shown as a frame 1 is essentially a vertical plate made of a rigid material that can be affixed or housed within any surface where the electronic display assembly 100 is to be installed using any known method of fixation. FIG. 3 shows how L-shaped plates 16 with screws 17 can be used to secure the frame 1 to the tilting mechanism 5. While one possible method of fixation is shown, what is contemplated is the use of any device or system, including but not limited to magnets, sliding locks, encased surfaces, adhesive, metal fixation plates, etc. It is understood by one of ordinary skill in the design of frame openings that access is provided to the display surface when light is allowed to pass through the frame allowing a user to perceive the display surface. Also, access is provided to an audio speaker when sound waves are able to pass the frame into the ambient medium, or that access is provided to a sensor if the detection technology of the sensor is able to pass the enclosure. The second opening 84 is either a physical opening or an effective opening in the enclosure material that allows infrared light waves to reach the sensor 7.

It is understood by a person of ordinary skill in the art that while a single power outlet 15 for the supply of the electronic display assembly is discussed, use of several other power input sockets or either alternative current (AC) or direct current (DC) for each of the main components or the use of a relay power supply within one of the main component is contemplated and shown partly on FIG. 3 as the connection cables 26, 37, 34, 35, 36, 25, and 38. These cables can be made to transfer data or power or both. In one preferred embodiment, 12-volt DC current may be used to power the proximity sensor 7, the tilting mechanism 5, and the audio speaker (not shown). The power supply 19 is operatively coupled to the display assembly 100, which is in turn coupled to all of the elements that need energy to operate properly. Again, it is understood by one of ordinary skill in the art that all elements within the computing device 21, such as a system to operate software, access video data, the possible audio data, or the elements of the electronic display assembly as associated to the computing device, such as the input and output USB port or any other appropriate connector, are appropriately energized.

The electronic touch screen display device 3 is equipped with a display surface 2 by which a user may interface with the audio and/or video data and the computing device 21. It is understood by one of ordinary skill in the art that while the display surface 2 width-over-height ratio shown and disclosed are those most commonly used in the industry, namely the ratios 4:3 or 16:9, any possible ratio is contemplated. While the use of a flat screen of either liquid crystal display (LCD) or plasma display technology is disclosed as the current best mode, it is understood that other display technology standards such as cathode ray tube (CRT), digital light processing (DLP), surface-conduction electron-emitter display (SED), FIELD EMISSION DISPLAY (FED), or any other new display technology may be used. A single display surface 2 may be rotated and used in either a landscape orientation or a portrait orientation in two different reinforced shell 4 and frame 1, each designed for its specific type of display. It is also understood by one of ordinary skill in the art that while rectangular 4:3 and 16:9 display surfaces are preferred in this art, other types of surface geometries of a display screen can be used based on user preferences and market availability, such as the use of flexible screens and displays of irregular shapes.

FIG. 4 illustrates only one of a number of possible different tilting mechanisms 5 that may be used to change the orientation of the electronic display device 3 within the frame 1 of the electronic display assembly 100. In one embodiment, the tilting mechanism 5 is mounted partly on the frame 1 and partly on the reinforced shell 4 and includes a male gear 64 connected to the reinforced shell 4 by two bolts 58. A motor 13 is connected to the control board 18 and rotates a first drive shaft 31 in a fashion shown by arrow 50. The use of a gear box 56 is contemplated to change the orientation of the drive shaft 31 from a vertical alignment to a horizontal alignment 60 via a second drive shaft 32 and ultimately a planetary gear 54 connected to the motor 13.

FIG. 4 shows how the tilting mechanism 5 includes an external case 65 fixed to the frame 1 via the L-shaped plates 16 with screws 17. The external case 65 includes a knob 53 in the center of the case 65 for holding the male gear 64 in place adjacent to the planetary gear 54. A bearing set 57 can be used within the male gear 64 to help with the rotation of the male gear 64 over the external case knob 53 when the tilting mechanism 5 is engaged. In one embodiment, the different orientations of the electronic display device 3 compared with the frame 1 correspond to different orientation of the male gear 64 within the tilting mechanism 5. The use of a light emitting diode (LED) 41 connected to a power source 42 for sending light to three light sensors 28 (only one shown in FIG. 4) also connected to a power source 26 associated with each of the three possible orientations is shown. The placement of the three light sensors 28 at different positions to obtain different angular variations is also shown. Tabs, magnets, proximity sensors, switches, or other devices to monitor and control the tilting mechanism 5 are further disclosed.

In yet another embodiment, communication between the electronic display device 3 and the computing device 21 is conducted via a serial port connected via a USB cable and serial to USB converter. In a protocol of communication in ASCII text format, a string of information is sent with a first Y or N bit to indicate whether the presence of user in front of the electronic display assembly 100 has been detected by the sensor 7. The second part of the information string is the position of the monitor in relation with the three light sensors 28, which is sent to provide position data to the computing device 21.

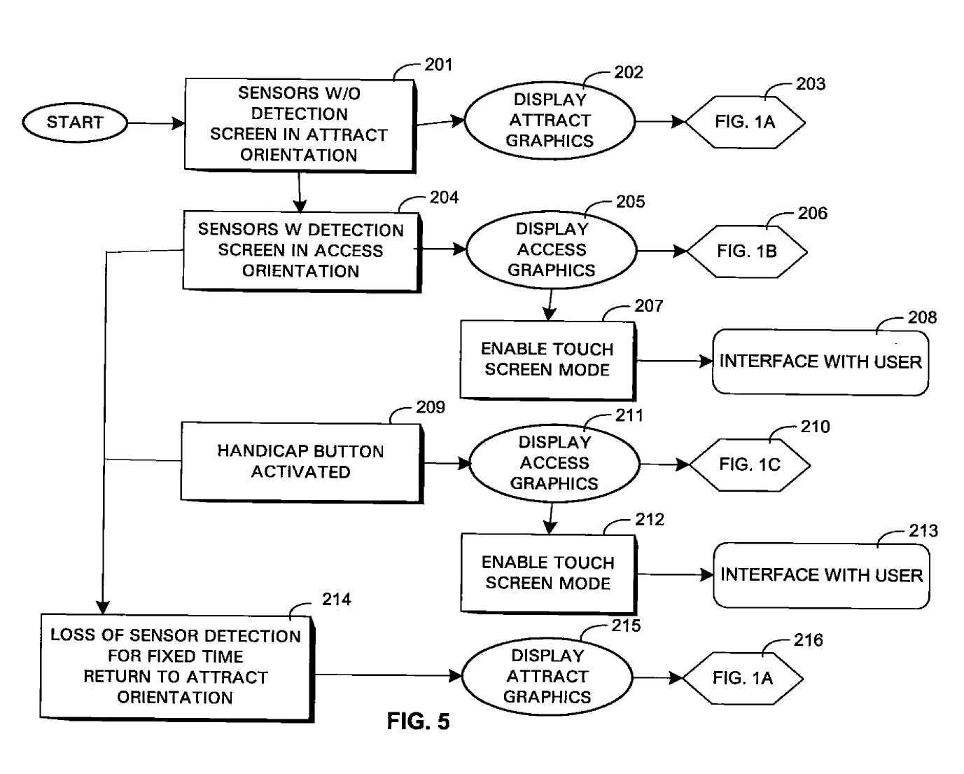

FIG. 5 is a block diagram of the method of tilting an electronic display assembly according to another embodiment of the present disclosure. The method consists of using a tilting electronic display assembly 100 according to the successive or nonsuccessive steps of placing a proximity sensor 7 and a display surface 2 of a tilting electronic display assembly 100 having a frame 1, an electronic display 3 with the display surface 2 pivotally connected to the frame 1, the proximity sensor 7, a switch 6 in visual relationship with an area of use, and a computing device 21 connected to the display surface 2 with a memory (not shown) for storing an attract graphic, and an access graphic. An attract graphic is defined as a multimedia presentation or any other type of visual or audio stimuli capable of attracting the attention of a potential user located in the area of use within the sensory range of the proximity sensor 7. Once the assembly 100 is in place, the sensor 7 is activated to detect a user within the area of use.

If the sensor 7 does not detect a user, the screen is placed in an attract orientation 201 and displays on the display surface 2 the attract graphic 202 as illustrated by FIG. 1A 203. The attract graphic is taken from the memory using the computing device 21. In a subsequent step, the electronic display 3 of the assembly 100 is pivoted to an access orientation 204 once the sensor 7 detects a user. The display surface 2 is then programmed to display the access graphic 205 from the memory using the computing device 21 as shown in FIG. 1B.

The touch screen is then activated 207 in anticipation of interfacing with the user 208. If the user has failed to touch the display surface 2 after a fixed period of time, such as in 30 seconds, the computer device 21 may reset the assembly 100 to the attract orientation 214 and display attract graphics 215 as shown in FIG. 1A 216.

In an alternate method, the steps include activating 209 the switch 6 and pivoting the electronic display 3 in a handicap orientation as shown in FIG. 1C 210 if the switch is pressed along with a display on the display surface 2 of the access graphics 211.

It is understood that the preceding is merely a detailed description of some examples and embodiments of the present invention and that numerous changes to the disclosed embodiments can be made in accordance with the disclosure herein without departing from the spirit or scope of the invention. The preceding description, therefore, is not meant to limit the scope of the invention but to provide sufficient disclosure to one of ordinary skill in the art to practice the invention without undue burden.

What is claimed is:

1. An electronic display assembly comprising:
a frame;
an electronic display device pivotally connected to the frame, the display device having a display surface, a control board, and a tilting mechanism and the display device for moving the electronic display device and the frame among an attract orientation, an access orientation, and a handicap orientation;
a proximity sensor with a detection level, the sensor connected to the control board; and
a switch connected to the control board,
wherein the control board energizes the tilting mechanism to pivot the electronic display device from the attract orientation to the access orientation when the detection level is reached, and to pivot the electronic display device from the access orientation to the handicap orientation when the switch is closed.

2. The electronic display assembly of claim 1, wherein the electronic display device further comprises a reinforced shell, and wherein the tilting mechanism is mounted partly on the frame and partly on the reinforced shell and includes a male gear connected to the reinforced shell, a motor connected to the control board, and a planetary gear connected to the motor.

3. The electronic display assembly of claim 2, wherein the switch is touch sensitive.

4. The electronic display assembly of claim 2, wherein the display surface is touch screen, and the switch is a portion of the touch screen.

5. The electronic display assembly of claim 1, wherein the electronic display device further includes at least a communication port, and the electronic display assembly further comprising a computing device with at least one data port connected to the communication port, at least one audio speaker, and a power supply.

6. The electronic display assembly of claim 2, wherein the frame includes a first opening forming a first edge connected to the switch, a second opening forming a second edge connected to the proximity sensor, and a third opening forming a third edge for housing the reinforced shell.

7. The electronic display assembly of claim 1, wherein the attract orientation is essentially vertical, the access orientation is offset by approximately 10 degrees from the attract orientation, and the handicap orientation is offset by approximately minus 10 degrees from the attract orientation.

8. The electronic display assembly of claim 1, wherein the sensor is a digital infrared emitter and receiver.

9. The electronic display assembly of claim 5, wherein the communication port and the data port are universal serial buses (USB).

10. The electronic display assembly of claim 2, wherein the tilting mechanism further includes a positioning device for placing the tilting mechanism by control of the motor from the attract orientation to the access orientation or the handicap orientation using a light emitting diode and three light sensors each associated with one of the attract orientation, the access orientation, and the handicap orientation.

11. A method for using a tilting electronic display assembly, the method comprises the steps of:
placing a tilting electronic display assembly having a frame, an electronic display with the display surface device pivotally connected to the frame, the proximity sensor, a switch in visual relationship with an area of use, and a computing device connected to the display surface with a memory for storing an attract graphic and an access graphic in the area of use;
activating the sensor to detect a user within the area of use;
pivoting the electronic display in an attract orientation and display on the display surface the attract graphic from the memory using the computing device;
pivoting the electronic display in an access orientation once the sensor detects a user and displaying on the display surface the access graphic from the memory using the computing device;
activating a touch screen mode on the display surface for an interface of the tilting electronic display assembly with the user; and
pivoting the electronic display in an attract orientation and displaying on the display surface of the attract graphic from the memory using the computing device once the sensor no longer detects the user.

12. The method for using a tilting electronic display assembly of claim 11, the method further comprises the steps of activating the switch and pivoting the electronic display in a handicap orientation when the switch is pressed.

13. The method for using a tilting electronic display assembly of claim 11, wherein pivoting the electronic display in the attract orientation once the sensor no longer detects the user occurs only if a touch on the display surface is not detected for a fixed period of time.

14. The method for using a tilting electronic display assembly of claim 13, wherein the fixed period of time is approximately 30 seconds.
